(19) United States
(12) Patent Application Publication
(10) Pub. No.: US 2026/0043704 A1
(43) Pub. Date: Feb. 12, 2026

(54) METHOD AND APPARATUS FOR DETERMINING VACUUM LEVEL THRESHOLD, DEVICE, MEDIUM, AND PRODUCT

(71) Applicant: DONGFANG JINGYUAN ELECTRON CO., LTD., Beijing (CN)

(72) Inventors: Di Wang, Beijing (CN); Yang Xi, Beijing (CN); Chenkai Liang, Beijing (CN); Qingtao Wang, Beijing (CN); Hongbiao Zhang, Beijing (CN); Jinfeng Shi, Beijing (CN); Chunying Han, Beijing (CN)

(21) Appl. No.: 19/364,996

(22) Filed: Oct. 21, 2025

(30) Foreign Application Priority Data
Nov. 6, 2024 (CN) 202411578180.1

(51) Int. Cl. G01L 21/00

(52) U.S. Cl. CPC G01L 21/00

(57) ABSTRACT

The present application discloses a method and apparatus for determining a vacuum level threshold, a device, a medium, and a product, relating to the technical field of electron beam measurement. The method includes: performing an evacuating operation on a transfer chamber of a charged particle beam imaging apparatus after a target wafer is introduced into the transfer chamber; obtaining vacuum levels in the transfer chamber at a plurality of time points during the evacuating operation; searching for a first target vacuum level curve matching the vacuum levels at the plurality of time points from a plurality of first vacuum level curves in a database; and determining the vacuum level stabilization value corresponding to the first target vacuum level curve as a target vacuum level threshold of the transfer chamber corresponding to the target wafer.

### CROSS-REFERENCE TO RELATED APPLICATIONS

This application claims priority to Chinese Patent Application No. 202411578180.1, titled “METHOD AND APPARATUS FOR DETERMINING VACUUM LEVEL THRESHOLD, DEVICE, MEDIUM, AND PRODUCT” and filed on Nov. 6, 2024, which is hereby incorporated by reference in its entirety.

### TECHNICAL FIELD

The present application belongs to the technical field of electron beam measurement, and in particular, relates to a method and apparatus for determining a vacuum level threshold, a device, a medium, and a product.

### BACKGROUND

In an existing electron beam measurement device, a transfer chamber serves as a transition between atmospheric and vacuum states. Before electron beam measurement is performed, the transfer chamber which a wafer is disposed needs to be evacuated to a preset vacuum level threshold, and then a transfer valve is opened to transfer the wafer to a main vacuum chamber, so as to avoid the occurrence of significant vacuum fluctuations in the main vacuum chamber.

In an existing method, equipment is first switched to a corresponding mode, the transfer chamber is evacuated until reaching a vacuum level threshold preset in this mode, and then an evacuation valve of the transfer chamber is closed to stop evacuating the transfer chamber. If the vacuum level in the transfer chamber does not fall below the preset vacuum level threshold after a period of time, the wafer is transferred to the main chamber.

However, if the vacuum level in the transfer chamber is less than the preset vacuum level threshold after the period of time, it indicates that the wafer is still outgassing, the accuracy of the preset vacuum level threshold is low, and the transfer chamber needs to be further evacuated. As such, the low accuracy of the vacuum level threshold set for the transfer chamber may greatly extend the evacuation time, resulting in a low measurement throughput of the transfer chamber.

### SUMMARY

Embodiments of the present application provide a method and apparatus for determining a vacuum level threshold, a device, a medium, and a product, which can increase the measurement throughput of a transfer chamber.

One aspect of the embodiments of the present application provides a method for determining a vacuum level threshold, including:
performing an evacuating operation on a transfer chamber of a charged particle beam imaging apparatus after a target wafer is introduced into the transfer chamber;
obtaining vacuum levels in the transfer chamber at a plurality of time points during the evacuating operation;
searching for a first target vacuum level curve matching the vacuum levels at the plurality of time points from first vacuum level curves in a database, where the database includes a plurality of the first vacuum level curves and corresponding vacuum level stabilization values, and each of the first vacuum level curves is configured for characterizing a variation trend of the vacuum level in the transfer chamber after wafers with different outgassing rates are introduced; and
determining the vacuum level stabilization value corresponding to the first target vacuum level curve as a target vacuum level threshold of the transfer chamber corresponding to the target wafer.

One aspect of the embodiments of the present application provides an apparatus for determining a vacuum level threshold, including:
a transfer chamber evacuating module, configured to perform an evacuating operation on a transfer chamber of a charged particle beam imaging apparatus after a target wafer is introduced into the transfer chamber;
a vacuum level obtaining module, configured to obtain vacuum levels in the transfer chamber at a plurality of time points during the evacuating operation;
a curve matching module, configured to search for a first target vacuum level curve matching the vacuum levels at the plurality of time points from first vacuum level curves in a database, where the database includes a plurality of the first vacuum level curves and corresponding vacuum level stabilization values, and each of the first vacuum level curves is configured for characterizing a variation trend of the vacuum level in the transfer chamber after wafers with different outgassing rates are introduced;
a threshold determining module, configured to determine the vacuum level stabilization value corresponding to the first target vacuum level curve as a target vacuum level threshold of the transfer chamber corresponding to the target wafer.

One aspect of the embodiments of the present application provides an electronic device, including: a memory and a program or instructions stored on the memory and executable on a processor, where the program or instructions, when executed by the processor, implement the method for determining a vacuum level threshold as provided in any one aspect of the embodiments of the present application.

One aspect of the embodiments of the present application provides a readable storage medium, storing a program or instructions that, when executed by a processor, implement the method for determining a vacuum level threshold as provided in any one aspect of the embodiments of the present application.

One aspect of the present application provides a computer program product, where instructions in the computer program product, when executed by a processor of an electronic device, enable the electronic device to perform the method for determining a vacuum level threshold as provided in any one aspect of the embodiments of the present application.

In the method for determining a vacuum level threshold according to the embodiments of the present application, the database is preset, which stores the first vacuum level curves corresponding to the introduction of wafers with different outgassing rates into the transfer chamber, as well as the vacuum level stabilization values corresponding to the first vacuum level curves. Then, the vacuum levels in the transfer chamber where the target wafer is located during the evacuating operation at the plurality of time points are compared with the first vacuum level curves in the database to obtain the first target vacuum level curve corresponding to the target wafer. Accordingly, an outgassing rate type corresponding to the target wafer can be determined, and the vacuum level threshold of the transfer chamber where the target wafer is located can be accurately obtained. Therefore, in the embodiments of the present application, the vacuum level threshold of the transfer chamber where the target wafer is located is accurately determined through the first target vacuum level curve matching the target wafer. The problem of great extension of the evacuation time due to an inaccurate vacuum level threshold is avoided, and the measurement throughput of the transfer chamber can be improved.

### BRIEF DESCRIPTION OF THE DRAWINGS

In order to explain the technical solutions of the embodiments of the present application more clearly, the drawings required for use in the embodiments of the present application will be briefly introduced below. Those skilled in the art can derive other drawings based on the drawings without any creative effort.

FIG. 1 is a schematic flowchart of a method for determining a vacuum level threshold according to an embodiment of the present application;

FIG. 2 is a schematic diagram of a standard gas pressure curve of a transfer chamber where a target wafer is located according to an embodiment of the present application;

FIG. 3 is a schematic structural diagram of an apparatus for determining a vacuum level threshold according to an embodiment of the present application; and

FIG. 4 is a schematic structural diagram of a device for determining a vacuum level threshold according to an embodiment of the present application.

### DETAILED DESCRIPTION

Features and exemplary embodiments of various aspects of the present application will be described in detail below. In order to make the objectives, technical solutions, and advantages of the present application clearer, the present application will be further described in detail below with reference to the drawings and specific embodiments. It should be understood that the specific embodiments described here are only intended to explain the present application, but not to limit the present application. For those skilled in the art, the present application can be implemented without some of these specific details. The following descriptions of the embodiments are merely for providing a better understanding of the present application by showing examples of the present application.

It should be noted that the relational terms herein, such as first and second, are merely used for distinguishing one entity or operation from another entity or operation, and do not necessarily require or imply that any actual relationship or sequence exists between these entities or operations. Moreover, the terms “include”, “comprise”, and any variants thereof are intended to cover a non-exclusive inclusion, such that a process, method, article, or device including a series of elements not only includes those elements, but further includes other elements not listed explicitly, or includes inherent elements of the process, method, article, or device. In the absence of more limitations, the expression “include an element” does not exclude other same elements existing in the process, method, article, or device including the element.

It should be noted that the collection, storage, use, processing, etc. of data in the technical solutions of the present application comply with the relevant provisions of national laws and regulations.

It should be noted that, in the embodiments of the present application, certain existing industry solutions such as software, components, or models may be referenced. These references should be considered exemplary, are merely intended to illustrate feasibility in the implementation of the technical solutions of the present application, and do not imply that the applicant had used or necessarily used such solutions.

In an existing method, equipment is first switched to a corresponding mode, a transfer chamber is evacuated until reaching a vacuum level threshold preset in this mode, and then an evacuation valve of the transfer chamber is closed to stop evacuating the transfer chamber. If the vacuum level in the transfer chamber does not fall below the preset vacuum level threshold after a period of time, a wafer is transferred to a main chamber. However, in this method, the low accuracy of the vacuum level threshold set for the transfer chamber may greatly extend the evacuation time, resulting in a low measurement throughput of the transfer chamber.

The present application aims to provide a method and apparatus for determining a vacuum level threshold, a device, a medium, and a product. In the method for determining a vacuum level threshold according to the embodiments of the present application, a database is preset, which stores first vacuum level curves corresponding to the introduction of wafers with different outgassing rates into a transfer chamber, as well as vacuum level stabilization values corresponding to the first vacuum level curves. Then, vacuum levels at a plurality of time points in the transfer chamber where a target wafer is located during the evacuating operation are compared with the first vacuum level curves in the database to obtain a first target vacuum level curve corresponding to the target wafer. Accordingly, an outgassing rate type corresponding to the target wafer can be determined, and a vacuum level threshold of the transfer chamber where the target wafer is located can be accurately obtained. Therefore, in the embodiments of the present application, the vacuum level threshold of the transfer chamber where the target wafer is located is accurately determined through the first target vacuum level curve matching the target wafer. The problem of great extension of the evacuation time due to an inaccurate vacuum level threshold is avoided, and the measurement throughput of the transfer chamber can be improved.

Specific embodiments of the method and apparatus for determining a vacuum level threshold, the device, the medium, and the product provided by the present application are introduced below. Firstly, the method for determining a vacuum level threshold is introduced.

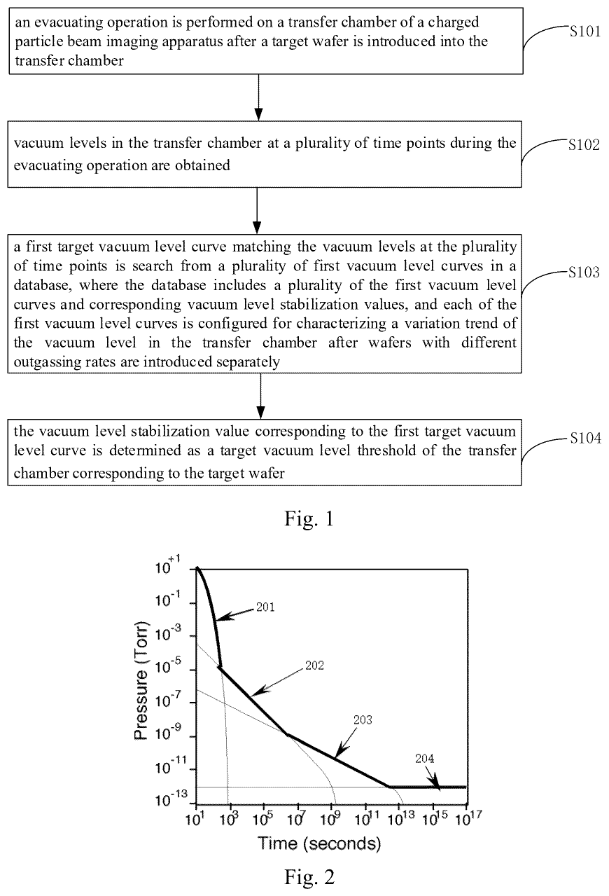

FIG. 1 provides a schematic flowchart of a method for determining a vacuum level threshold. The method for determining a vacuum level threshold may be applied to a server side and includes S101 to S104 below.

In S101: An evacuating operation is performed on a transfer chamber of a charged particle beam imaging apparatus after a target wafer is introduced into the transfer chamber.

In this embodiment, the evacuating operation refers to a process of evacuating air, non-condensable gas, and moisture in the transfer chamber by using a device such as a vacuum pump, so as to achieve a relatively vacuum state. Such an operation is configured to adjust the vacuum level in the transfer chamber, so as to satisfy a condition of transferring the target wafer in the transfer chamber to a main vacuum chamber.

In S102: Vacuum levels in the transfer chamber at a plurality of time points during the evacuating operation are obtained.

In this embodiment, the vacuum level in the transfer chamber varies in real time during the evacuating operation of the transfer chamber. That is, the vacuum level in the transfer chamber at each time point is different during the evacuating operation.

As an example, the server side is equipped with a sensor in the transfer chamber, and the sensor can measure and record vacuum level data in real time. After the target wafer enters the transfer chamber, the sensor is activated to record vacuum level data in the transfer chamber at a plurality of time points (such as every 1 second or 5 seconds or a time interval set according to actual needs).

The sensor may be a capacitive, piezoresistive, or thermal conductivity vacuum gauge, and the vacuum level data includes timestamps and corresponding vacuum level values.

In S103: A first target vacuum level curve matching the vacuum levels at the plurality of time points is search from a plurality of first vacuum level curves in a database, where the database includes a plurality of the first vacuum level curves and corresponding vacuum level stabilization values, and each of the first vacuum level curves is configured for characterizing a variation trend of the vacuum level in the transfer chamber after wafers with different outgassing rates are introduced separately.

In this embodiment, the plurality of first vacuum level curves are pre-stored in the database, and each first vacuum level curve corresponds to one specific outgassing rate of wafers and characterizes a variation trend of the vacuum level in the transfer chamber after the wafers with the corresponding outgassing rate are introduced.

As an example, the server side finds the first target vacuum level curve most matching the current vacuum level data by comparing the recorded vacuum level data with the first vacuum level curves in the database.

The matching process may be implemented by using an algorithm, such as a least squares method, dynamic time warping (DTW), or a machine learning model.

In S104: The vacuum level stabilization value corresponding to the first target vacuum level curve is determined as a target vacuum level threshold of the transfer chamber corresponding to the target wafer.

In this embodiment, the vacuum level stabilization value is a vacuum level value at which the vacuum level tends to stabilize in the first target vacuum level curve.

As an example, after finding the first target vacuum level curve, the server side obtains a vacuum level stabilization value from the first target vacuum level curve, and determines the vacuum level stabilization value corresponding to the first target vacuum level curve as the target vacuum level threshold corresponding to the target wafer.

Then, the server side continues to monitor the vacuum level in the transfer chamber. When the vacuum level is superior to or not inferior to the target vacuum level threshold, a transfer mechanism is triggered to securely transfer the target wafer from the transfer chamber to the main vacuum chamber for next processing.

The superior vacuum level represents lower gas pressure in the transfer chamber. The transfer mechanism may be a robotic arm, a conveyor belt, or any other automation device, depending on the layout of a production line and the sizes of wafers. In the method for determining a vacuum level threshold provided in the embodiments, the database is preset, which stores the first vacuum level curves corresponding to the introduction of wafers with different outgassing rates into the transfer chamber, as well as the vacuum level stabilization values corresponding to the first vacuum level curves. Then, the vacuum levels in the transfer chamber where the target wafer is located during the evacuating operation at the plurality of time points are compared with the first vacuum level curves in the database to obtain the first target vacuum level curve corresponding to the target wafer. Accordingly, an outgassing rate type corresponding to the target wafer can be determined, and the vacuum level threshold of the transfer chamber where the target wafer is located can be accurately obtained. Therefore, in the embodiments of the present application, the vacuum level threshold of the transfer chamber where the target wafer is located is accurately determined through the first target vacuum level curve matching the target wafer. The problem of great extension of the evacuation time due to an inaccurate vacuum level threshold is avoided, and the measurement throughput of the transfer chamber can be improved.

As an optional embodiment, after S102, the method for determining a vacuum level threshold may further include:
obtaining a fluctuation duration of the vacuum level from onset to stabilization in the first target vacuum level curve; and
in a case that the difference between the fluctuation duration and a current actual evacuation duration corresponding to the evacuating operation performed on the transfer chamber is greater than a preset interval duration, periodically obtaining vacuum levels in the transfer chamber at the plurality of time points within a preset time period until a preset condition is satisfied, so as to obtain a second target vacuum level curve,
where the preset condition is that a difference between the current actual evacuation duration of the transfer chamber and a fluctuation duration of a second vacuum level curve is less than or equal to the preset interval duration, and the second vacuum level curve is the first vacuum level curve in the database that matches the vacuum levels at the plurality of time points that are periodically obtained.

S104 may specifically include:
determining the vacuum level stabilization value corresponding to the second target vacuum level curve as the target vacuum level threshold of the transfer chamber corresponding to the target wafer. In this embodiment, the fluctuation duration refers to a time period during which the vacuum level starts to fluctuate from an initial value until reaching a stable state, that is, a predicted evacuation duration corresponding to the vacuum level curve.

The current actual evacuation duration is configured for characterizing a duration from a starting time of performing the evacuation operation on the transfer chamber to a current time. Exemplarily, the current actual evacuation duration may be 5 seconds, 10 seconds, or 15 seconds. As an example, the server side obtains the first target vacuum level curve, and then obtains a fluctuation duration T1 corresponding to the first target vacuum level curve based on a time corresponding to a first vacuum level and a time corresponding to a vacuum level first reaching a stable state in the first target vacuum level curve.

Then, a current actual evacuation duration T2 of the transfer chamber is obtained, and the current actual evacuation duration T2 is subtracted from the fluctuation duration T1 to obtain ΔT. If ΔT is greater than a preset interval (for example, 10 seconds), vacuum level data of the transfer chamber at the plurality of time points within a preset time period (for example, every 5 seconds) is further periodically obtained.

Next, all the obtained vacuum level data are matched with the preset first vacuum level curves in the database to find the first vacuum level curve matching the vacuum levels at a plurality of time points within the current actual evacuation duration, so as to obtain a second vacuum level curve.

The above steps are repeated until a difference between the current actual evacuation duration (T2′) of the transfer chamber and the fluctuation duration (T1′) of the second vacuum level curve is less than or equal to the preset interval duration, the final corresponding second vacuum level curve is determined as the second target vacuum level curve, and the vacuum level stabilization value corresponding to the second target vacuum level curve is determined as the target vacuum level threshold corresponding to the target wafer.

Through this embodiment, the vacuum levels in the transfer chamber at the plurality of time points within the preset time period are periodically obtained, and then periodically matched with the first vacuum level curves in the database until a predicted end time of evacuation is approaching. By obtaining the vacuum levels in the transfer chamber as much as possible, the accuracy of matching can be improved, and the vacuum level threshold of the transfer chamber where the target wafer is located can be accurately determined.

As an optional embodiment, before periodically obtaining vacuum levels in the transfer chamber at the plurality of time points within a preset time period, the method for determining a vacuum level threshold may further include:
determining a duration of the preset time period based on the difference between the fluctuation duration and the current actual evacuation duration, where the duration of the preset time period is less than the difference.

In this embodiment, assuming the fluctuation duration is 20 seconds and the current actual evacuation duration is 5 seconds, the difference between the fluctuation duration and the current actual evacuation duration is 15 seconds, that is, there is still 15 seconds until a predicted evacuation end.

In this case, the preset time period should be less than 15 seconds, so as to avoid extension of the evacuation time and relatively low measurement throughput of the transfer chamber due to excessive evacuation for more than 15 seconds.

Furthermore, the preset time period may be as close as possible to the difference between the fluctuation duration and the current actual evacuation duration. Exemplarily, assuming the difference between the fluctuation duration and the current actual evacuation duration is 15 seconds and the preset interval duration is 5 seconds, the vacuum level threshold of the transfer chamber where the target wafer is located should be determined 5 seconds before the predicted evacuation end.

Therefore, the preset time period can be directly set to 15−5=10 seconds. In this case, only one cyclic obtaining of vacuum levels is required, that is, only one matching verification with the first vacuum level curves in the database is required, which can reduce the repeatability of computation and the consumption of computing resources.

Through this embodiment, the duration of the preset time period is determined based on the difference between the fluctuation duration and the current actual evacuation duration, which is conducive to subsequent cyclic obtaining of vacuum levels within the preset time period. By obtaining the vacuum levels in the transfer chamber as much as possible, the accuracy of matching can be improved, and the vacuum level threshold of the transfer chamber where the target wafer is located can be accurately determined.

As an optional embodiment, S103 may specifically include:
fitting the vacuum levels at the plurality of time points to obtain a third vacuum level curve of the transfer chamber; and
searching for the first target vacuum level curve matching the third vacuum level curve from the first vacuum level curves in the database.

In this embodiment, the third vacuum level curve is a variation trend curve of the vacuum levels of the target wafer in the transfer chamber, which is obtained by fitting the vacuum levels at the plurality of time points.

As an example, during the process of evacuating or maintaining a vacuum state in the transfer chamber, the server side obtains vacuum level data at the plurality of time points in real time by using a high-precision vacuum level sensor.

Then, the obtained vacuum level data at the plurality of time points are input into a fitting algorithm, such as polynomial fitting, exponential fitting or neural network fitting, for fitting to obtain the third vacuum level curve. The third vacuum level curve can accurately reflect the change law of the vacuum level over time in the transfer chamber where the target wafer is located.

Next, the third vacuum level curve is matched with each first vacuum level curve in the database by using an appropriate matching algorithm. The matching algorithm can be used for comparison based on features parameters, such as the shape, slope, maximum value, and minimum value of the curve.

Finally, based on a matching degree (such as similarity or error), the first vacuum level curve best matching the third vacuum level curve is selected as the first target vacuum level curve.

Through this embodiment, the vacuum level data at the plurality of time points are fitted to obtain the third vacuum level curve, and the first target vacuum level curve matching the third vacuum level curve is searched from the database. Accordingly, based on the first target vacuum level curve in the database, the target vacuum level threshold corresponding to the target wafer can be accurately determined.

As an optional embodiment, after searching for a first target vacuum level curve matching the vacuum levels at the plurality of time points from first vacuum level curves in a database, the method for determining a vacuum level threshold may further include:
outputting process prompt information in a case that there is no first target vacuum level curve matching the third vacuum level curve in the database, where the process prompt information is configured for warning that the target wafer has experienced process fluctuations; and
updating the database in response to a user operation of inputting a standard vacuum level curve corresponding to the target wafer, where the standard vacuum level curve is configured for characterizing a standard variation trend of the vacuum level in the transfer chamber after the target wafer is introduced.

In this embodiment, the process prompt information is output in the event of matching failure to warn the user that the target wafer has experienced process fluctuations, that is, the process flow of the target wafer differs from conventional process flows corresponding to various wafers in the database.

Based on the process prompt information, the user obtains the standard vacuum level curve of the transfer chamber where the target wafer is located, and stores the standard vacuum level curve in the database to update the database.

Exemplarily, the standard vacuum level curve may be obtained by converting a standard gas pressure curve of the transfer chamber where the target wafer is located. The standard gas pressure curve is configured for characterizing standard variations of gas pressure in the transfer chamber where the target wafer is located during the evacuating operation.

FIG. 2 shows a standard gas pressure curve of the transfer chamber where the target wafer is located. The gas pressure in the transfer chamber where the target wafer is located decreases over time and eventually stabilizes. Specifically, the standard gas pressure curve includes totally four stages.

In a first stage 201, gas within the volume of the chamber is mainly evacuated by a backing pump or a rough vacuum pump (usually a dry pump). On the actual equipment, this stage is accomplished by a high-speed dry pump of the equipment within a relatively short time. When the pressure reaches a working range of a molecular pump, a second stage 202 begins. In the second stage, the molecular pump starts to evacuate gas mainly adsorbed on the surface. As the pressure continues to drop, the vacuum level gradually increases, the gas adsorbed on the surface is gradually evacuated, and then a third stage 203 begins. In the third stage, what is evacuated is mainly gas released from the surface and gas resulting from diffusion of internal dissolved gas. Finally, a fourth stage 204 begins, where the gas pressure tends to stabilize.

As an example, the server side first matches the collected third vacuum level curve with each first vacuum level curve in the database.

In a case that there is no first target vacuum level curve matching the third vacuum level curve in the database, process prompt information is output to warn that the target wafer has experienced process fluctuations. The process prompt information includes, but is not limited to: wafer number, transfer chamber number, vacuum level data, etc.

Then, in response to the user operation of inputting the standard vacuum level curve corresponding to the target wafer, the server side updates the database and stores the standard vacuum level curve input by the user in the database.

Through this embodiment, in a case that there is no first target vacuum level curve matching the third vacuum level curve in the database, the database is updated in a timely manner based on the user input standard vacuum level curve corresponding to the target wafer. In this way, the process fluctuations can be warned and at the same time, the reliability of subsequent database matching can be improved.

As an optional embodiment, after searching for a first target vacuum level curve matching the vacuum levels at the plurality of time points from first vacuum level curves in a database, the method for determining a vacuum level threshold may further include:
in a case that there is the first target vacuum level curve matching the third vacuum level curve in the database, obtaining a first vacuum level variation rate corresponding to the third vacuum level curve and second vacuum level variation rates corresponding to the first vacuum level curves within the current evacuation duration for which the evacuating operation is performed on the transfer chamber;
comparing the first vacuum level variation rate with the second vacuum level variation rates to obtain vacuum level comparison results;
the determining the vacuum level stabilization value corresponding to the first target vacuum level curve as a target vacuum level threshold of the transfer chamber corresponding to the target wafer comprises:
determining a wafer transfer condition corresponding to the target wafer based on the vacuum level comparison results; and
transferring the target wafer from the transfer chamber to a main vacuum chamber when the wafer transfer condition is satisfied.

In this embodiment, the first vacuum level variation rate is configured for characterizing variations of the vacuum level in the third vacuum level curve.

The second vacuum level variation rates are configured for characterizing, in the first vacuum level curves, variations of the vacuum level corresponding to the third vacuum level curve within the current evacuation duration.

The vacuum level comparison results are configured for characterizing magnitude relationships between the first vacuum level variation rate and the second vacuum level variation rates.

The wafer transfer condition is configured for characterizing a condition that needs to be satisfied when the target wafer is transferred from the transfer chamber to the main vacuum chamber.

As an example, in a case that there is the first target vacuum level curve matching the third vacuum level curve in the database, the server side obtains the first vacuum level variation rate corresponding to the third vacuum level curve in real time.

Then, based on the current evacuation duration corresponding to the third vacuum level curve, the second vacuum level variation rates within the corresponding current evacuation duration corresponding to the first vacuum level curves are extracted from the database. The first vacuum level variation rate of the third vacuum level curve is compared in magnitude with the second vacuum level variation rates of the first vacuum level curves to obtain the vacuum level comparison results.

Finally, based on the vacuum level comparison results and preset wafer transfer condition determination rules, whether the target wafer satisfies the wafer transfer condition is determined. When it is determined that the wafer transfer condition is satisfied, a wafer transfer apparatus is activated to transfer the target wafer from the transfer chamber to the main vacuum chamber.

Optionally, the vacuum level comparison results may include two types of results: the first vacuum level variation rate is greater than each second vacuum level variation rate, and the first vacuum level variation rate is less than each second vacuum level variation rate.

When the first vacuum level variation rate is greater than each second vacuum level variation rate, it can be determined that the evacuation speed of the transfer chamber where the target wafer is located is greater than that of the transfer chamber where each other wafer in the database is located. The wafer transfer condition may be set as follows: the duration of the target wafer staying in the transfer chamber reaches a shortest transfer time corresponding to each first vacuum level curve in the database.

When the first vacuum level variation rate is less than each second vacuum level variation rate, it can be determined that the evacuation speed of the transfer chamber where the target wafer is located is less than that of the transfer chamber where each other wafer in the database is located. The wafer transfer condition may be set as follows: the duration of the target wafer staying in the transfer chamber reaches a preset multiple of a longest transfer time corresponding to each first vacuum level curve in the database.

Through this embodiment, a method for determining a wafer transfer condition by comparing vacuum level variation rates is provided in a case that there is the first target vacuum level curve matching the third vacuum level curve in the database. Accordingly, when a wafer satisfies the transfer condition, the wafer is transferred to the main vacuum chamber, which can ensure smooth transfer of each wafer to the main vacuum chamber.

As an optional embodiment, when the vacuum level comparison results indicate that the first vacuum level variation rate is greater than each of the second vacuum level variation rates, the wafer transfer condition is that the duration of the target wafer staying in the transfer chamber satisfies a preset shortest waiting time; or
when the vacuum level comparison results indicate that the first vacuum level variation rate is less than that each of the second vacuum level variation rates, the wafer transfer condition is that the vacuum level in the transfer chamber where the target wafer is located is equal to the vacuum level of the main vacuum chamber.

In this embodiment, the shortest waiting time is configured for characterizing a shortest time that a wafer needs to wait from entering the transfer chamber to being transferred to the main vacuum chamber.

As an example, when the first vacuum level variation rate is greater than each second vacuum level variation rate, it can be determined that the evacuation speed of the transfer chamber where the target wafer is located is greater than that of the transfer chamber where each other wafer in the database is located.

In this case, the vacuum level in the transfer chamber where the target wafer is located can satisfy the transfer condition within a relatively short time. Therefore, the wafer transfer condition is set as such that the duration of the target wafer staying in the transfer chamber satisfies the preset shortest waiting time.

When the first vacuum level variation rate is less than each second vacuum level variation rate, it can be determined that the evacuation speed of the transfer chamber where the target wafer is located is less than that of the transfer chamber where each other wafer in the database is located.

In this case, the vacuum level in the transfer chamber where the target wafer is located can satisfy the transfer condition within a relatively long time. Therefore, the wafer transfer condition is set as such that the vacuum level in the transfer chamber where the target wafer is located is equal to the vacuum level of the main vacuum chamber.

Through this embodiment, a corresponding wafer transfer condition is set according to the magnitude relationship between the first vacuum level variation rate and each second vacuum level variation rate. Thus, when a wafer satisfies the transfer condition, the wafer is transferred to the main vacuum chamber, which can ensure smooth transfer of each wafer to the main vacuum chamber.

As an optional embodiment, the wafer transfer condition is that the vacuum level in the transfer chamber where the target wafer is located is equal to the vacuum level of the main vacuum chamber; and
after determining a wafer transfer condition corresponding to the target wafer based on the vacuum level comparison results, the method for determining a vacuum level threshold may further include:
obtaining a quantity of wafers in the transfer chamber where the target wafer is located; and
in a case that there is a single wafer, controlling the transfer chamber to communicate with the main vacuum chamber; or
in a case that there are a plurality of wafers, controlling a moving component to move other wafers except the target wafer out of the transfer chamber, and controlling the transfer chamber to communicate with the main vacuum chamber.

In this embodiment, the moving component is configured for moving the wafers. Exemplarily, the moving component may be a robotic arm.

The server side first detects the quantity and positions of wafers in the transfer chamber through sensors to determine the position of the target wafer and the presence of other wafers in the transfer chamber.

If the sensors detect a single wafer in the transfer chamber, that is, the target wafer is a unique wafer, an isolation valve between the transfer chamber and the main vacuum chamber is controlled to open, so that the transfer chamber communicates with the main vacuum chamber.

If the sensors detect a plurality of wafers in the transfer chamber, the moving component is first controlled to move other wafers except the target wafer out of the transfer chamber, and the other wafers can be temporarily stored in other storage positions or transferred back to a wafer supply region. Then, the isolation valve between the transfer chamber and the main vacuum chamber is controlled to open, so that the transfer chamber communicates with the main vacuum chamber.

Through this embodiment, by controlling the transfer chamber to communicate with the main vacuum chamber, molecular pumps in the main vacuum chamber and the transfer chamber can jointly perform the evacuating operation. Therefore, vacuum fluctuations in the main vacuum chamber can be prevented, and the evacuation time of the transfer chamber can be further shortened.

Based on the method for determining a vacuum level threshold, correspondingly, the present application further provides specific embodiments of an apparatus for determining a vacuum level threshold.

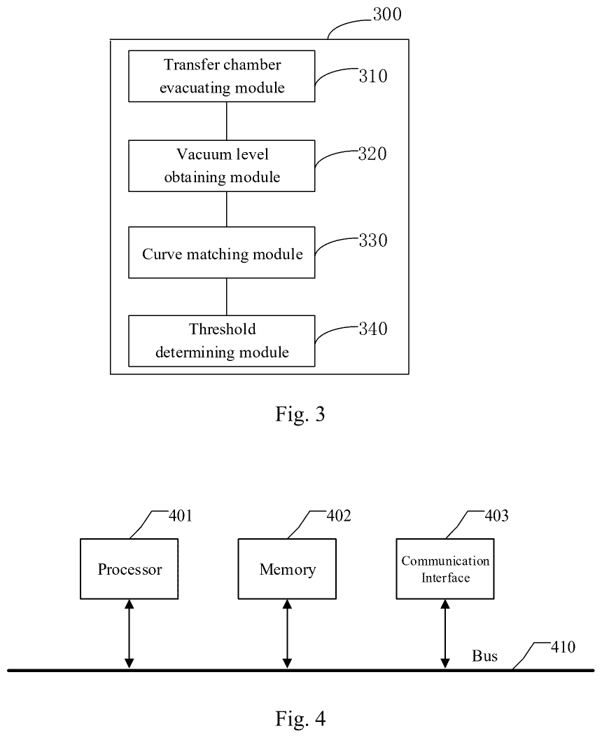

As shown in FIG. 3, the apparatus for determining a vacuum level threshold 300 provided in the embodiments of the present application includes a transfer chamber evacuating module 310, a vacuum level obtaining module 320, a curve matching module 330, and a threshold determining module 340.

The transfer chamber evacuating module 310 is configured to perform an evacuating operation on a transfer chamber of a charged particle beam imaging apparatus after a target wafer is introduced into the transfer chamber.

The vacuum level obtaining module 320 is configured to obtain vacuum levels in the transfer chamber at a plurality of time points during the evacuating operation;

The curve matching module 330 is configured to search for a first target vacuum level curve matching the vacuum levels at the plurality of time points from first vacuum level curves in a database, where the database includes a plurality of the first vacuum level curves and corresponding vacuum level stabilization values, and each of the first vacuum level curves is configured for characterizing a variation trend of the vacuum level in the transfer chamber after wafers with different outgassing rates are introduced.

The threshold determining module 340 is configured to determine the vacuum level stabilization value corresponding to the first target vacuum level curve as a target vacuum level threshold of the transfer chamber corresponding to the target wafer.

As an optional embodiment, after searching for a first target vacuum level curve matching the vacuum levels at the plurality of time points from first vacuum level curves in a database, the apparatus 300 for determining a vacuum level threshold may further include the following modules:
a duration obtaining module, configured to obtain a fluctuation duration of the vacuum level from onset to stabilization in the first target vacuum level curve; and
a cyclic execution module, configured to, when the difference between the fluctuation duration and a current actual evacuation duration corresponding to the evacuating operation performed on the transfer chamber is greater than a preset interval duration, periodically obtain vacuum levels in the transfer chamber at the plurality of time points within a preset time period until a preset condition is satisfied, so as to obtain a second target vacuum level curve.

Here the preset condition is that a difference between the current actual evacuation duration of the transfer chamber and a fluctuation duration of a second vacuum level curve is less than or equal to the preset interval duration, and the second vacuum level curve is the first vacuum level curve in the database that matches the vacuum levels at the plurality of time points that are periodically obtained.

The threshold determining module 340 is specifically configured to:
determine the vacuum level stabilization value corresponding to the second target vacuum level curve as the target vacuum level threshold of the transfer chamber corresponding to the target wafer.

As an optional embodiment, before periodically obtaining vacuum levels in the transfer chamber at the plurality of time points within a preset time period, the apparatus for determining a vacuum level threshold 300 may further include the following modules:
a duration determining module, configured to determine a duration of the preset time period based on the difference between the fluctuation duration and the current actual evacuation duration, where the duration of the preset time period is less than the difference.

As an optional embodiment, the curve matching module 330 specifically includes the following units:
a curve fitting unit, configured to fit the vacuum levels at the plurality of time points to obtain a third vacuum level curve of the transfer chamber; and
a curve matching unit, configured to search for the first target vacuum level curve matching the third vacuum level curve from the first vacuum level curves in the database.

As an optional embodiment, after searching for a first target vacuum level curve matching the vacuum levels at the plurality of time points from first vacuum level curves in a database, the apparatus 300 for determining a vacuum level threshold may further include the following modules:
a process prompt module, configured to output process prompt information in a case that there is no first target vacuum level curve matching the third vacuum level curve in the database, where the process prompt information is configured for warning that the target wafer has experienced process fluctuations; and
a database update module, configured to update the database in response to a user operation of inputting a standard vacuum level curve corresponding to the target wafer, where the standard vacuum level curve is configured for characterizing a standard variation trend of the vacuum level in the transfer chamber after the target wafer is introduced.

As an optional embodiment, before determining the vacuum level stabilization value corresponding to the first target vacuum level curve as a target vacuum level threshold of the transfer chamber corresponding to the target wafer, the apparatus 300 for determining a vacuum level threshold may further include the following modules:
a variation rate obtaining module, configured to obtain, in a case that there is the first target vacuum level curve matching the third vacuum level curve in the database, a first vacuum level variation rate corresponding to the third vacuum level curve and second vacuum level variation rates corresponding to the first vacuum level curves within the current evacuation duration for which the evacuating operation is performed on the transfer chamber;
a variation rate comparing module, configured to compare the first vacuum level variation rate with the second vacuum level variation rates to obtain vacuum level comparison results;
a condition determining module, configured to determine a wafer transfer condition corresponding to the target wafer based on the vacuum level comparison results; and
a wafer transfer module, configured to transfer the target wafer from the transfer chamber to a main vacuum chamber when the wafer transfer condition is satisfied.

As an optional embodiment, the wafer transfer condition is that the vacuum level in the transfer chamber where the target wafer is located is equal to the vacuum level of the main vacuum chamber; and
after determining a wafer transfer condition corresponding to the target wafer based on the vacuum level comparison results, the apparatus 300 for determining a vacuum level threshold may further include the following modules:
a data obtaining module, configured to obtain a quantity of wafers in the transfer chamber where the target wafer is located; and
a transfer chamber control module, configured to control, in a case that there is a single wafer, the transfer chamber to communicate with the main vacuum chamber.

Moreover, the transfer chamber control module is further configured to control, in a case that there are a plurality of wafers, a moving component to move other wafers except the target wafer out of the transfer chamber, and control the transfer chamber to communicate with the main vacuum chamber.

Based on the method for determining a vacuum level threshold, correspondingly, the present application further provides specific embodiments of a device for determining a vacuum level threshold.

FIG. 4 shows a hardware structure of a device for determining a vacuum level threshold according to an embodiment of the present application.

The device for determining a vacuum level threshold may include a processor 401 and a memory 402 storing computer program instructions.

Specifically, the processor 401 may include a central processing unit (CPU), or an application specific integrated circuit (ASIC), or may be configured as one or more integrated circuits to implement the embodiments of the present application.

The memory 402 may include a mass memory for data or instructions. By way of example and not limitation, the memory 402 may be a hard disk drive (HDD), a floppy disk drive, a flash memory, an optical disk, a magneto-optical disk, a magnetic tape, or a universal serial bus (USB) drive, or a combination of two or more of these. Where appropriate, the memory 402 may include a removable or non-removable (or fixed) medium. Under appropriate circumstances, the memory 402 may be located either inside or outside a disaster recovery device of an integrated gateway. In a specific embodiment, the memory 402 is a non-volatile solid state memory.

The processor 401 reads and executes the computer program instructions stored in the memory 402 to implement any method for determining a vacuum level threshold in the above embodiments.

In one example, the device for determining a vacuum level threshold may further include a communication interface 403 and a bus 410. As shown in FIG. 4, the processor 401, the memory 402, and the communication interface 403 are connected and communicate with each other through the bus 410.

The communication interface 403 is mainly configured to implement communication between various modules, apparatuses, units, and/or devices in the embodiments of the present application.

The bus 410 includes hardware, software, or both, which couples the components of the device for determining a vacuum level threshold together. By way of example and not limitation, the bus may include accelerated graphics port (AGP) or other graphics buses, enhanced industrial standard architecture (EISA) buses, front end buses (FSB), hyper transport (HT) interconnects, industrial standard architecture (ISA) buses, unlimited bandwidth interconnects, low pin count (LPC) buses, memory buses, microchannel architecture (MCA) buses, peripheral component interconnects (PCI) buses, PCI-Express (PCI-X) buses, serial advanced technology accessory (SATA) buses, video electronics standards association local (VLB) buses or other suitable buses, or a combination of two or more of these. Where appropriate, the bus 410 may include one or more buses. Although the embodiment of the present application describes and shows a specific bus, the present application considers any suitable bus or interconnect.

Moreover, in combination with the method for determining a vacuum level threshold in the above embodiments, an embodiment of the present application may provide a computer storage medium for implementation. The computer storage medium stores computer program instructions. The computer program instructions, when executed by the processor, implement any method for determining a vacuum level threshold in the above embodiments.

Moreover, in combination with the method for determining a vacuum level threshold in the above embodiments, an embodiment of the present application may provide a computer program product for implementation. When instructions in the computer program product are executed by a processor of an electronic device, the electronic device is enabled to perform the method for determining a vacuum level threshold provided in any one aspect of the above embodiments of the present application.

It should be clear that the present application is not limited to the specific configuration and processing described above and shown in the drawings. For the sake of simplicity, detailed descriptions of known methods are omitted here. In the aforementioned embodiments, several specific steps are described and shown as examples. However, the method process of the present application is not limited to the specific steps described and shown. After understanding the gist of the present application, those skilled in the art can make various changes, modifications and additions, or change the order between the steps.

The functional blocks shown in the above structural block view can be implemented as hardware, software, firmware, or a combination thereof. When implemented in hardware, the functional blocks can be, for example, an electronic circuit, an application-specific integrated circuit (ASIC), appropriate firmware, plug-ins, function cards, etc. When implemented in software, the elements of the present application are programs or code segments used to perform required tasks. The programs or code segments may be stored in a machine-readable medium, or transmitted over a transmission medium or communication link through data signals carried in carrier waves. The “machine-readable medium” may include any medium that can store or transmit information. Examples of the machine-readable medium include an electronic circuit, a semiconductor memory device, an ROM, a flash memory, an erasable ROM (EROM), a floppy disk, a CD-ROM, an optical disk, a hard disk, an optical fiber medium, a radio frequency (RF) link, etc. The code segments may be downloaded via a computer network such as the Internet and Intranet.

It should also be noted that the exemplary embodiments mentioned in the present application describe some methods or systems based on a series of steps or apparatuses. However, the present application is not limited to the order of the above steps, that is, the steps may be performed in the order mentioned in the embodiments or in an order different from that in the embodiments, or several steps may be performed simultaneously.

The above describes various aspects of the present application with reference to the flowcharts and/or block views of the method, apparatus (system), and computer program product according to the embodiments of the present application. It should be understood that each box in the flowchart and/or block view and a combination of boxes in the flowchart and/or block view can be implemented by computer program instructions. These computer program instructions can be provided to a processor of a general-purpose computer, a dedicated computer, or other programmable data processing apparatuses to produce a machine, which enables the instructions executed by the processor of the computer or other programmable data processing apparatuses to implement the functions/actions specified in one or more boxes of the flowchart and/or block view. Such a processor may be, but is not limited to a general-purpose processor, a dedicated processor, a special application processor, or a field programmable logic circuit. It can also be understood that each box in the block view and/or flowchart and a combination of boxes in the block view and/or flowchart can be implemented by dedicated hardware that executes specified functions or actions, or by a combination of dedicated hardware and computer instructions.

Described above are merely specific implementations of the present application. Those skilled in the art can clearly understand that, for the sake of convenience and briefness in description, the specific working processes of the above-described systems, modules and units may refer to the corresponding processes in the embodiments of the aforementioned methods, and details are not described herein again. It should be understood that the protection scope of the present application is not limited thereto. Those skilled in the art can readily conceive various equivalent modifications or replacements within the technical scope disclosed by the present application, and these modifications or replacements shall fall within the protection scope of the present application.

What is claimed is:

1. A method for determining a vacuum level threshold, comprising:
performing an evacuating operation on a transfer chamber of a charged particle beam imaging apparatus after a target wafer is introduced into the transfer chamber;
obtaining vacuum levels in the transfer chamber at a plurality of time points during the evacuating operation;
searching for a first target vacuum level curve matching the vacuum levels at the plurality of time points from a plurality of first vacuum level curves in a database, wherein the database comprises the plurality of first vacuum level curves and corresponding vacuum level stabilization values, and each of the first vacuum level curves is configured for characterizing a variation trend of the vacuum level in the transfer chamber after wafers with different outgassing rates are introduced separately; and
determining the vacuum level stabilization value corresponding to the first target vacuum level curve as a target vacuum level threshold of the transfer chamber corresponding to the target wafer.

2. The method according to claim 1, wherein after the searching for a first target vacuum level curve matching the vacuum levels at the plurality of time points from a plurality of first vacuum level curves in a database, the method further comprises:
obtaining a fluctuation duration of the vacuum level from onset to stabilization in the first target vacuum level curve; and
in a case that a difference between the fluctuation duration and a current actual evacuation duration corresponding to the evacuating operation performed on the transfer chamber is greater than a preset interval duration, periodically obtaining vacuum levels in the transfer chamber at a plurality of time points within a preset time period until a preset condition is satisfied, so as to obtain a second target vacuum level curve,
wherein the preset condition is that a difference between the current actual evacuation duration of the transfer chamber and a fluctuation duration of a second vacuum level curve is less than or equal to the preset interval duration, and the second vacuum level curve is the first vacuum level curve in the database that matches the vacuum levels at the plurality of time points that are periodically obtained; and
wherein the determining the vacuum level stabilization value corresponding to the first target vacuum level curve as a target vacuum level threshold of the transfer chamber corresponding to the target wafer comprises:
determining the vacuum level stabilization value corresponding to the second target vacuum level curve as the target vacuum level threshold of the transfer chamber corresponding to the target wafer.

3. The method according to claim 2, wherein before the periodically obtaining vacuum levels in the transfer chamber at a plurality of time points within a preset time period, the method further comprises;
determining a duration of the preset time period based on the difference between the fluctuation duration and the current actual evacuation duration, wherein the duration of the preset time period is less than the difference.

4. The method according to claim 1, wherein the searching for a first target vacuum level curve matching the vacuum levels at the plurality of time points from a plurality of first vacuum level curves in a database comprises:
fitting the vacuum levels at the plurality of time points to obtain a third vacuum level curve of the transfer chamber; and
searching for the first target vacuum level curve matching the third vacuum level curve from the plurality of first vacuum level curves in the database.

5. The method according to claim 4, wherein after the searching for a first target vacuum level curve matching the vacuum levels at the plurality of time points from the plurality of first vacuum level curves in a database, the method further comprises:
outputting process prompt information in a case that there is no first target vacuum level curve matching the third vacuum level curve in the database, wherein the process prompt information is configured for warning that the target wafer has experienced process fluctuations; and
updating the database in response to a user operation of inputting a standard vacuum level curve corresponding to the target wafer, wherein the standard vacuum level curve is configured for characterizing a standard variation trend of the vacuum level in the transfer chamber after the target wafer is introduced.

6. The method according to claim 4, wherein after the searching for a first target vacuum level curve matching the vacuum levels at the plurality of time points from the plurality of first vacuum level curves in a database, the method further comprises:
in a case that there is the first target vacuum level curve matching the third vacuum level curve in the database, obtaining a first vacuum level variation rate corresponding to the third vacuum level curve and second vacuum level variation rates corresponding to the first vacuum level curves within the current evacuation duration for which the evacuating operation is performed on the transfer chamber;
comparing the first vacuum level variation rate with the second vacuum level variation rates to obtain vacuum level comparison results;
wherein the determining the vacuum level stabilization value corresponding to the first target vacuum level curve as a target vacuum level threshold of the transfer chamber corresponding to the target wafer comprises:
determining a wafer transfer condition corresponding to the target wafer based on the vacuum level comparison results; and
transferring the target wafer from the transfer chamber to a main vacuum chamber in a case that the wafer transfer condition is satisfied.

7. The method according to claim 6, wherein in a case that the vacuum level comparison results indicate that the first vacuum level variation rate is greater than each of the second vacuum level variation rates, the wafer transfer condition is that a duration of the target wafer in staying the transfer chamber satisfies a preset shortest waiting time; or
in a case that the vacuum level comparison results indicate that the first vacuum level variation rate is less than that each of the second vacuum level variation rates, the wafer transfer condition is that the vacuum level in the transfer chamber where the target wafer is located is equal to the vacuum level of the main vacuum chamber.

8. The method according to claim 7, wherein the wafer transfer condition is that the vacuum level in the transfer chamber where the target wafer is located is equal to the vacuum level of the main vacuum chamber; and
after the determining a wafer transfer condition corresponding to the target wafer based on the vacuum level comparison results, the method further comprises:
obtaining a quantity of wafers in the transfer chamber where the target wafer is located; and
controlling, in a case that there is a single wafer, the transfer chamber to communicate with the main vacuum chamber;
controlling, in a case that there are a plurality of wafers, a moving component to move other wafers except the target wafer out of the transfer chamber, and controlling the transfer chamber to communicate with the main vacuum chamber.

9. An electronic device, comprising a processor and a memory storing computer program instructions, wherein the processor performs the method for determining the vacuum level threshold comprising: performing an evacuating operation on a transfer chamber of a charged particle beam imaging apparatus after a target wafer is introduced into the transfer chamber;
obtaining vacuum levels in the transfer chamber at a plurality of time points during the evacuating operation; searching for a first target vacuum level curve matching the vacuum levels at the plurality of time points from a plurality of first vacuum level curves in a database, wherein the database comprises the plurality of first vacuum level curves and corresponding vacuum level stabilization values, and each of the first vacuum level curves is configured for characterizing a variation trend of the vacuum level in the transfer chamber after wafers with different outgassing rates are introduced separately; and determining the vacuum level stabilization value corresponding to the first target vacuum level curve as a target vacuum level threshold of the transfer chamber corresponding to the target wafer; when executing the computer program instructions.

10. A non-transitory computer-readable storage medium, storing computer program instructions that, when executed by a processor, implement the method for determining the vacuum level threshold comprising: performing an evacuating operation on a transfer chamber of a charged particle beam imaging apparatus after a target wafer is introduced into the transfer chamber; obtaining vacuum levels in the transfer chamber at a plurality of time points during the evacuating operation; searching for a first target vacuum level curve matching the vacuum levels at the plurality of time points from a plurality of first vacuum level curves in a database, wherein the database comprises the plurality of first vacuum level curves and corresponding vacuum level stabilization values, and each of the first vacuum level curves is configured for characterizing a variation trend of the vacuum level in the transfer chamber after wafers with different outgassing rates are introduced separately; and determining the vacuum level stabilization value corresponding to the first target vacuum level curve as a target vacuum level threshold of the transfer chamber corresponding to the target wafer.

11. A computer program product, wherein instructions in the computer program product, when executed by a processor of an electronic device, enable the electronic device to perform the method for determining the vacuum level threshold according to claim 1.
